(19) United States
(12) Patent Application Publication
(10) Pub. No.: US 2015/0357100 A1
(43) Pub. Date: Dec. 10, 2015

(54) NANOCOMPOSITE MAGNET AND METHOD OF PRODUCING THE SAME

(71) Applicant: TOYOTA JIDOSHA KABUSHIKI KAISHA, Toyota-shi (JP)

(72) Inventors: Masao YANO, Sunto-gun (JP); Tetsuya SHOJI, Toyota-shi (JP); Akira MANABE, Miyoshi-shi (JP); Noritsugu SAKUMA, Mishima-shi (JP); Masaaki ITO, Susono-shi (JP)

(21) Appl. No.: 14/730,961

(22) Filed: Jun. 4, 2015

(30) Foreign Application Priority Data
Jun. 5, 2014 (JP) 2014-116830

(51) Int. Cl. H01F 1/057; C22C 1/02; C22C 38/00; H01F 1/055; H01F 41/02

(52) U.S. Cl. CPC H01F 1/057; H01F 1/055; H01F 41/0253; C22C 38/005; C22C 38/002; C22C 1/02

(57) ABSTRACT

A nanocomposite magnet includes grains including a shell of a Re-TM-B phase and a core of a TM or TM-B phase. Re is a rare earth element, and TM is a transition metal.

### INCORPORATION BY REFERENCE

The disclosure of Japanese Patent Application No. 2014-116830 filed on Jun. 5, 2014 including the specification, drawings and abstract is incorporated herein by reference in its entirety.

### BACKGROUND OF THE INVENTION

1. Field of the Invention

The present invention relates to a nanocomposite magnet having high coercive force and a method of producing the same.

2. Description of Related Art

The application of a permanent magnet has been spread in a wide range of fields including electronics, information and telecommunications, medical cares, machine tools, and industrial and automotive motors, and the demand for reduction in the amount of carbon dioxide emissions has increased. In such a situation, development of a high-performance permanent magnet has been increasingly expected along with the spread of hybrid vehicles, energy-saving in industrial fields, the improvement of power generation efficiency, and the like.

A Nd—Fe—B magnet (neodymium magnet) which is currently predominant in the market as a high-performance magnet is used as a magnet for a drive motor of a HV/EHV. Recently, the motor has been further reduced in size and increased in output (increased in the remanent magnetization of a magnet), and correspondingly, the Nd—Fe—B magnet has been increasingly required to be improved in performance, particularly in coercive force.

For example, since a neodymium magnet which is used as a drive motor of a hybrid vehicle or an electric vehicle necessarily operates at a high temperature, the magnetic force thereof is necessarily maintained at a high temperature. In order to achieve high output at a high temperature, the coercive force which is an index indicating the heat resistance of a magnet is required to be high. Hitherto, in order to increase the coercive force, dysprosium (Dy) which is a heavy rare earth element has been used. However, due to two points including the resource risk of Dy and a decrease in magnetization by Dy, a magnet with a decreased amount of Dy used is required. Further, recently, due to a recent exponential increase in hybrid vehicle demand, the resource risk problem has become an issue for a rare earth element such as neodymium (Nd) which is an essential element, and the development of a magnet with a decreased amount of a rare earth element used is urgently needed.

A study regarding a nanocomposite magnet has progressed to develop a material capable of obtaining higher performance than that of a Nd—Fe—B magnet and decreasing the amount of a rare earth element used. The nanocomposite magnet is composed of a Nd₂Fe₁₄B magnetic phase (main phase) and a magnetic phase including Fe as a major component. In this nanocomposite magnet, high energy product can be achieved by causing a soft magnetic phase (α-Fe phase) having high saturation magnetization to be present together with the Nd₂Fe₁₄B magnetic phase in the entire structure and then simultaneously developing characteristics of the two phases through an exchange coupling action. The nanocomposite magnet is considered as a promising concept capable of simultaneously realizing high coercive force and high saturation magnetization.

Various nanocomposite magnets using a Nd—Fe—B material have been proposed. For example, Japanese Patent Application Publication 2012-234985 (JP 2012-234985 A) discloses a method of producing a nanocomposite magnet which is a three-phase mixture including a Nd₂Fe₁₄B phase, an α-Fe phase, and a Nd—Cu phase, in which the Nd₂Fe₁₄B phase is a hard magnetic phase, and the α-Fe phase is a soft magnetic phase.

As described above, the nanocomposite magnet has a structure in which the nano-sized fine hard magnetic phase and the soft magnetic phase are present together. However, in a general method of producing a nanocomposite magnet, a non-magnetic phase (Nd—Cu) is brought into contact with a magnetic structure including a Nd₂Fe₁₄B phase, and the two phases are heated to a melting point or higher. As a result, the non-magnetic phase is diffused into grain boundaries of the magnetic phase. However, in a nanocomposite magnet produced using this method, the non-magnetic phase is present between the Fe phase as the soft magnetic phase and the Nd₂Fe₁₄B phase as the hard magnetic phase. Therefore, exchange coupling between the soft magnetic phase and the hard magnetic phase, from which the nanocomposite magnet is derived, is weakened by the non-magnetic phase, which may decrease the coercive force.

### SUMMARY OF THE INVENTION

The invention provides a nanocomposite magnet having high coercive force and a method of producing the same.

According to a first aspect of the invention, there is provided a nanocomposite magnet. The nanocomposite magnet includes grains including a shell of a Re-TM-B phase and a core of a TM or TM-B phase. Re is a rare earth element, and TM is a transition metal.

In the first aspect, the grains may be present in a Re-rich phase.

In the first aspect, the TM may be Fe, Co, Ni, or a combination thereof.

In the first aspect, the TM-B grains may be Fe—B grains.

In the first aspect, the Re may be Nd, Y, La, Ce, Pr, Sm, Gd, Tb, Dy, or a combination thereof.

In the first aspect, the M may be Ga, Zn, Si, Al, Fe, Co, Ni, Cu, Cr, Mg, Hg, Ag, or Au.

In the first aspect, the Re-M alloy may be a Nd—Cu alloy.

According to a second aspect of the invention, there is provided a method of producing a rare earth magnet. The method of producing a rare earth magnet includes: bringing a phase including nano-sized TM-B grains having an average grain size of 1 μm or less into contact with a Re-M alloy; heating the Re-M alloy to a melting point thereof or higher to be melted; and causing the molten Re-M alloy to diffusively penetrate into the TM-B grains. TM is a transition metal. Re is a rare earth element, and M is an element which decreases a melting point of the rare earth element when alloyed with the rare earth element.

In the second aspect, the TM may be Fe, Co, Ni, or a combination thereof.

In the second aspect, the TM-B grains may be Fe—B grains.

In the second aspect, the Re may be Nd, Y, La, Ce, Pr, Sm, Gd, Tb, Dy, or a combination thereof.

In the second aspect, the M may be Ga, Zn, Si, Al, Fe, Co, Ni, Cu, Cr, Mg, Hg, Ag, or Au.

In the second aspect, the Re-M alloy may be a Nd—Cu alloy.

In the second aspect, an average grain size of the TM-B grains may be 10 nm to 1 μm.

According to the first and second aspects, the rare earth element is caused to penetrate into the TM-B phase, and thus a structure is obtained in which the hard magnetic phase (Re-TM-B) is a shell, the soft magnetic phase (TM compound) is a core, and the non-magnetic phase (Nd—Cu) decouples grains of the hard magnetic phase. As a result, a nanocomposite magnet having high coercive force can be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an image showing diffusion penetration of Re-M;

FIG. 2 is a graph showing the XRD pattern of an example of the invention;

FIG. 3 is a graph showing the XRD pattern of an example of the invention; and

FIG. 4 is a graph showing the coercive forces of magnets obtained in examples of the invention.

### DETAILED DESCRIPTION OF EMBODIMENTS

A nanocomposite magnet according to an embodiment of the invention includes grains including a shell of a Re-TM-B phase (hard magnetic phase) and a core of a TM or TM-B phase (soft magnetic phase). In addition, by the grains being present in a Re-rich phase, the nanocomposite magnet according to the embodiment of the invention is composed of three phases including: the shell of the Re-TM-B phase (hard magnetic phase); the core of the TM or TM-B phase (soft magnetic phase); and the Re-rich phase that decouples grains of the hard magnetic phase.

A method of producing a nanocomposite magnet according to an embodiment of the invention includes the following steps: (1) a step of bringing a phase including nano-sized TM-B grains (wherein TM is a transition metal) having an average grain size of 1 or less into contact with a Re-M alloy (wherein Re is a rare earth element, and M is an element which decreases a melting point of the rare earth element when alloyed with the rare earth element); (2) a step of heating the Re-M alloy to a melting point thereof or higher to be melted; and (3) a step of causing the molten Re-M alloy to diffusively penetrate into the TM-B grains.

The TM-B grains used in Step (1) function as the core of the nanocomposite magnet obtained using the method according to the invention.

In the TM-B grains, TM is a transition metal, preferably Fe, Co, Ni, or a combination thereof, more preferably a compound containing Fe, and most preferably Fe.

The TM-B grains have a nanograin size of 1 μm or less and preferably have an average grain size of 10 nm to 300 nm. When the average grain size of the core-shell grains after the diffusion penetration is in this range, a ratio of single-domain grains is increased. “Single-domain” refers to a state where only one magnetic domain is present inside crystal grains thereof in the absence of a magnetic domain wall. In a structure where single-domain grains aggregate, the magnetization of each magnetic domain is changed by a magnetization rotation mechanism. Contrary to the single domain, “multi-domain” refers to a state where multiple domains are present inside crystal grains thereof in the presence of a magnetic domain wall. In a structure where multi-domain grains aggregate, the magnetization of each magnetic domain is changed by the movement of a magnetic domain wall. Accordingly, in the single-domain structure, a magnetic domain wall in the crystal grains does not move as compared to that of the multi-domain structure. Therefore, the magnetization is hardly changed, that is, the coercive force is improved. When the average grain size of the TM-B grains is more than 300 nm, the TM-B grains cannot maintain the single-domain structure after the diffusion penetration, which may cause a problem of a decrease in intrinsic coercive force. On the other hand, when the average grain size is decreased to be about 5 nm, the core of the obtained magnet exhibits isotropic magnetic characteristics. Accordingly, it is preferable that the grain size of the TM-B grains is limited to be 10 nm to 300 nm.

The TM-B grains can be produced using a common method. That is, for example, a liquid quenching method, an atomizing method, or a chemical synthesis method may be used. Specifically, a master alloy (alloy ingot obtained by casting) adjusted to have a target composition is melted to obtain a molten alloy. A method of melting the master alloy is not particularly limited as long as the master alloy can be heated to a melting point thereof or higher, and examples of the melting method include an arc melting method, a melting method using a heater, and a method using high frequency induction heating. The molten alloy having a target composition obtained as described above is treated using a well-known liquid quenching method to prepare a quenched ribbon. In this liquid quenching method, as described above, the alloy ingot obtained by casting is melted to obtain a molten alloy (molten liquid metal; typically melted at about 1400° C. using high-frequency induction heating or arc melting), and this molten alloy is quenched by being injected onto a rotating roll, thereby preparing a ribbon-shaped product (quenched ribbon). The material, size, and the like of the roll are not particularly limited. As the roll, for example, a Cr-plated copper roll may be used. The size of the roll is preferably determined according to the production scale.

This liquid quenching method is preferably performed in an inert gas atmosphere such as argon (Ar) or under a reduced pressure (typically, the pressure is reduced to be 10° Pa (=1 Pa) using a rotary pump) to prevent the oxidation degradation of the quenched ribbon. The quenching rate of the liquid quenching method, that is, the peripheral speed of the roll is not particularly limited, but is preferably 15 m/s to 50 m/s.

The Re-M alloy in contact with the phase containing the TM-B grains is a necessary component, when penetrating into the TM-B grains, to form the shell of the rare earth magnet obtained using the method according to the embodiment of the invention.

In the Re-M alloy, Re is a rare earth element, and M is an element which decreases a melting point of the rare earth element when alloyed with the rare earth element. As Re, one rare earth element or two or more rare earth elements can be used. For example, Nd, Y, La, Ce, Pr, Sm, Gd, Tb, Dy, or a combination thereof is preferably used, and Nd, Pr, Sm, Tb, Dy, or Gd is more preferably used. As M, for example, Ga, Zn, Si, Al, Fe, Co, Ni, Cu, Cr, Mg, Hg, Ag, or Au is preferably used, and Cu is more preferably used.

Typical examples of Re-M and melting points thereof are shown in the following table.

TABLE 1

| R-M | Melting Point (° C.) |
|---|---|
| Nd (Reference) | 1021 |
| Nd—Ga | 651 |
| Nd—Al | 635 |
| Nd—Cu | 520 |
| Nd—Mn | 700 |
| Nd—Mg | 551 |
| Nd—Hg | 665 |
| Nd—Fe | 640 |
| Nd—Co | 566 |
| Nd—Ag | 640 |
| Nd—Ni | 540 |
| Nd—Zn | 630 |
| Pr—Cu | 470 |

Next, in Step (2), the Re-M alloy is heated to a melting point thereof or higher to be melted. Next, in Step (3), the molten Re-M alloy is caused to diffusively penetrate into the TM-B grains. That is, the molten Re-M alloy penetrates through a contact surface with the TM-B grains and is diffused in the TM-B grains.

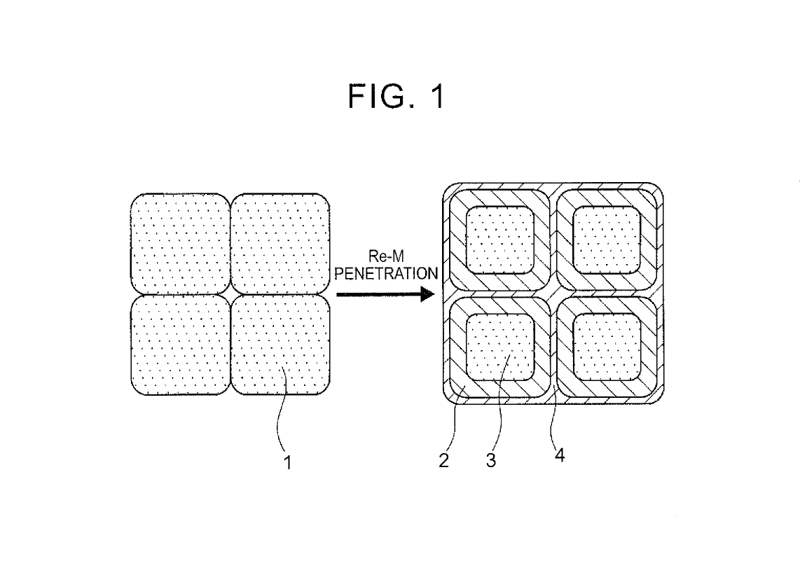

FIG. 1 schematically shows a state of the diffusion penetration of the Re-M alloy into the TM-B grains. On the left side (before the diffusion penetration) of FIG. 1, the phase containing the TM-B grains 1 is shown. When the Re-M alloy diffusively penetrates into this phase, Re-M starts to be diffused into the surfaces of the TM-B grains and gaps between the TM-B grains. Then, Re-M is dissolved in a TM-B compound, and due to contact therebetween, TM-B atoms are diffused at the contact portion, and thus a Re-TM-B phase 2 is formed. This Re-TM-B phase 2 forms a shell. On the other hand, the internal TM-B grains form a core 3 as TM-B or as TM depending on the diffusion degree of the TM-B atoms. Further, in each grain boundary 4, the remainder of Re-M which is not used for forming the shell phase is present as a Re-rich phase.

Here, the time of the diffusion penetration of the Re-M alloy into the phase including the TM-B grains may be appropriately adjusted such that a target core-shell structure can be achieved according to the kinds and characteristics (for example, melting point, grain size, and density) of the Re-M alloy and the TM-B grains. In addition, the mass ratio (with respect to the total mass of the magnet) of Re-M for the diffusion penetration may be appropriately adjusted.

The Re content in the Re-M alloy can be appropriately adjusted to obtain an appropriate melting point. For example, the Nd content in an Nd—Cu alloy, is preferably 50 at % to 82 at %. In this range, the melting point of the Nd—Cu alloy can be adjusted to be 700° C. or lower.

As described above, with the method according to the invention, a nanocomposite magnet is obtained which includes grains including a shell of a Re-TM-B phase (hard magnetic phase) and a core of a TM or TM-B phase (soft magnetic phase). In addition, by the grains being present in a Re-rich phase, the nanocomposite magnet is composed of three phases including: the shell of the Re-TM-B phase (hard magnetic phase); the core of the TM or TM-B phase (soft magnetic phase); and the Re-rich phase that decouples grains of the hard magnetic phase.

### EXAMPLES

Predetermined amounts of Fe and FeB were weighed so as to obtain a composition as shown in Table 2 below, and an alloy ingot was prepared in an arc melting furnace.

TABLE 2
Compositions of Prepared Samples and Amounts of Elements Added

| | Fe [g] | FeB [g] | Total [g] |
|---|---|---|---|
| Example 1 | 17.96 | 2.04 | 20.0 |
| Fe₉₂B₈ | | | |
| Example 2 | 15.30 | 4.70 | 20.0 |
| Fe₈₃B₁₇ | | | |
| Example 3 | 9.12 | 10.88 | 20.0 |
| Fe₆₇B₃₃ | | | |

Next, this alloy ingot was melted by high-frequency induction heating in an Ar-substituted reduced pressure atmosphere, and the molten alloy was injected on a copper rotating roll under a single-roll use condition shown in Table 3. As a result, a quenched ribbon having an average grain size of about 100 nm was prepared.

TABLE 3
Single-Roll Quenching Condition

| | | |
|---|---|---|
| Nozzle Diameter | 0.6 | mm |
| Injection Pressure | 0.4 | kg/cm³ |

| | |
|---|---|
| Roll Peripheral Speed | 24 m/s to 25 m/s |
| Melting Temperature During | 1400° C. to 1500° C. |
| Injection | |

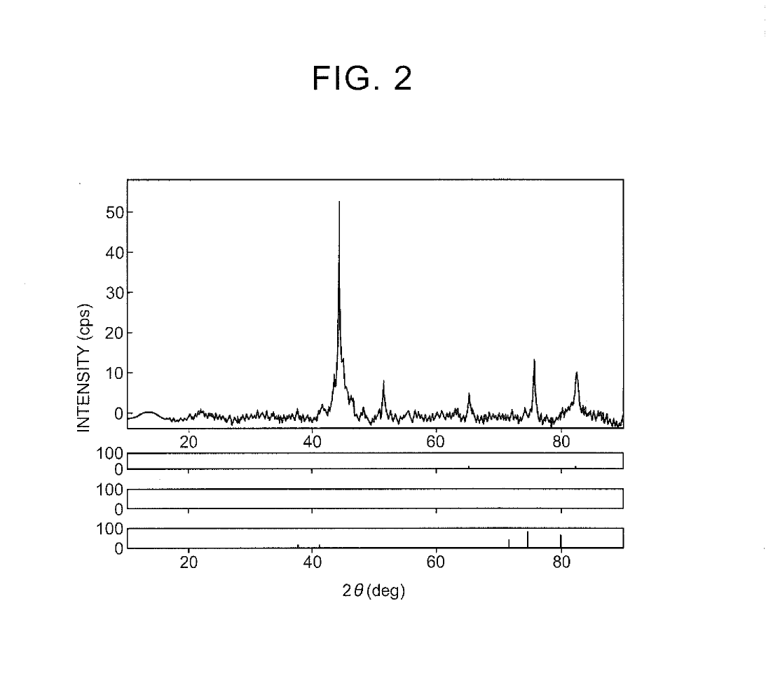

FIG. 2 shows the XRD pattern of the prepared quenched ribbon (Example 2). It can be seen from the above results that the phases of the obtained quenched ribbon were composed of α-Fe, Fe₂B, Fe₈B, and the like.

A Nd—Cu quenched ribbon prepared to have a composition of Nd₇₀Cu₃₀ was superimposed on the above-prepared Fe—B quenched ribbon, and the quenched ribbons were spot-welded. Next, a heat treatment was performed in a heating furnace of an Ar atmosphere under the following conditions: the welded quenched ribbons were heated to a heating temperature of 580° C. at a temperature increase rate of 40° C./min, were held at 580° C. for 60 minutes, and were furnace-cooled at a cooling rate of 20° C./min after completion of heating.

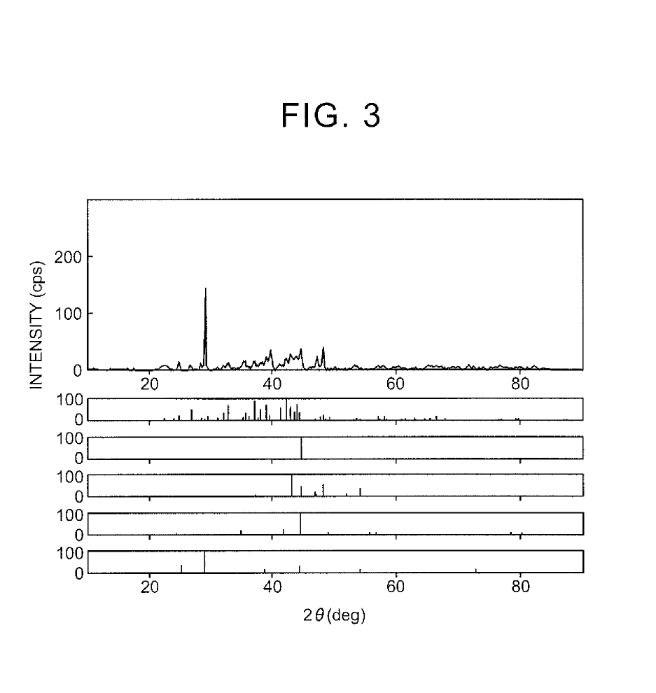

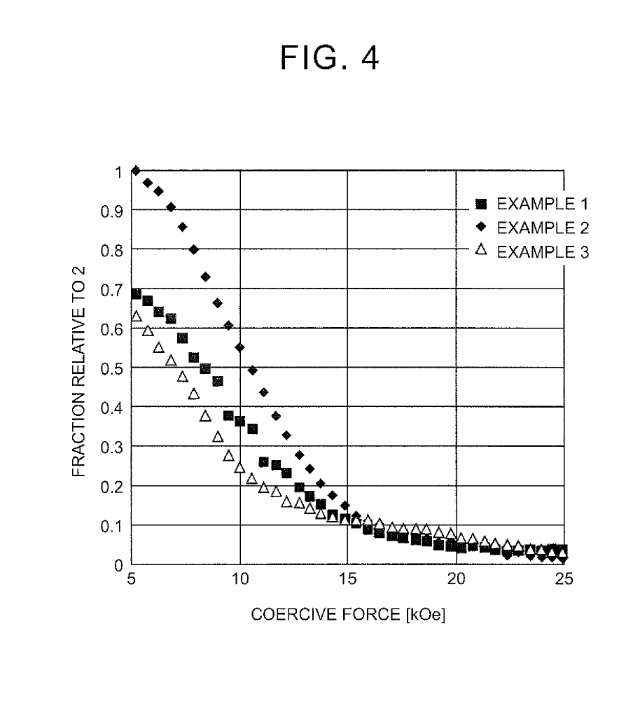

A surface of the heat-treated ribbon on which Nd—Cu was placed was polished to be provided for XRD measurement and magnetic characteristic measurement using VSM. FIG. 3 shows an XRD pattern after the heat treatment (Example 2). Not only Nd₂Fe₁₄B as a magnetic phase but also Nd₂O₃, FeₓB, and the like were observed. In addition, FIG. 4 shows the results of the magnetic characteristic measurement. High coercive force derived from the magnetic phase (Nd₂Fe₁₄B phase) was exhibited.

What is claimed is:

1. A nanocomposite magnet comprising:
grains including a shell of a Re-TM-B phase and a core of a TM or TM-B phase,
wherein Re is a rare earth element, and TM is a transition metal.

2. The nanocomposite magnet according to claim 1, wherein
the grains are present in a Re-rich phase.

3. The nanocomposite magnet according to claim 1, wherein
TM is Fe, Co, Ni, or a combination of at least two of Fe, Co or Ni.

4. The nanocomposite magnet according to claim 1, wherein
Re is Nd, Y, La, Ce, Pr, Sm, Gd, Tb, Dy, or a combination of at least two of Nd, Y, La, Ce, Pr, Sm, Gd, Tb or Dy.

5. The nanocomposite magnet according to claim 1, wherein
Re is introduced to the nanocomposite magnet from a Re-M alloy, and
M is Ga, Zn, Si, Al, Fe, Co, Ni, Cu, Cr, Mg, Hg, Ag, or Au.

6. The nanocomposite magnet according to claim 1, wherein
Re is introduced to the nanocomposite magnet from a Re-M alloy, and
the Re-M alloy is a Nd—Cu alloy.

7. A method of producing a nanocomposite magnet, the method comprising:
bringing a phase including nano-sized TM-B grains having an average grain size of 1 μm or less into contact with a Re-M alloy;
heating the Re-M alloy to a melting point or higher to be melted; and
causing the molten Re-M alloy to diffusively penetrate into the TM-B grains,
wherein TM is a transition metal,
Re is a rare earth element, and
M is an element which decreases a melting point of the rare earth element when alloyed with the rare earth element.

8. The method according to claim 7, wherein
TM is Fe, Co, Ni, or a combination of at least two of Fe, Co or Ni.

9. The method according to claim 7, wherein
the TM-B grains are Fe—B grains.

10. The method according to claim 7, wherein
Re is Nd, Y, La, Ce, Pr, Sm, Gd, Tb, Dy, or a combination of at least two of Nd, Y, La, Ce, Pr, Sm, Gd, Tb or Dy.

11. The method according to claim 7, wherein
M is Ga, Zn, Si, Al, Fe, Co, Ni, Cu, Cr, Mg, Hg, Ag, or Au.

12. The method according to claim 7, wherein
the Re-M alloy is a Nd—Cu alloy.

13. The method according to claim 7, wherein
the average grain size of the TM-B grains is 10 nm to 1 μm.
